(19) United States
(12) Patent Application Publication
(10) Pub. No.: US 2013/0343784 A1
(43) Pub. Date: Dec. 26, 2013

(54) DEVELOPING UNIT AND IMAGE FORMING APPARATUS INCLUDING THE SAME

(71) Applicant: Kyocera Document Solutions Inc., Osaka (JP)

(72) Inventors: Takeshi Fujimura, Osaka (JP); Ryoji Nishimura, Osaka (JP); Hiroaki Ohashi, Osaka (JP); Masahiro Kashimoto, Osaka (JP)

(21) Appl. No.: 13/924,127

(22) Filed: Jun. 21, 2013

(30) Foreign Application Priority Data
Jun. 25, 2012 (JP) 2012-141883

(51) Int. Cl. G03G 15/09

(52) U.S. Cl. CPC G03G 15/0889
USPC 399/255; 399/257; 399/272

(57) ABSTRACT

A developing unit according to an embodiment of the present disclosure includes a developer container, a stirring member, a magnetic roller, a developing roller, a developer supply port, and a developer discharge portion. The developer discharge portion includes a discharge blade having a spiral blade and conveying an excess developer, a developer discharge port through which the excess developer conveyed by the discharge blade is discharged outside of the developer container, and an air outlet through which an airflow in the developer container passes toward the outside of the developer container. The developer discharge port is located at a position lower than the upper surface of the developer present in the developer discharge portion; and the air outlet is located at a position higher than the upper surface of the developer present in the developer discharge portion.

### INCORPORATION BY REFERENCE

This application is based upon, and claims the benefit of priority from, corresponding Japanese Patent Application No. 2012-141883 filed in the Japan Patent Office on Jun. 25, 2012, the entire contents of which are incorporated herein by reference.

### BACKGROUND

Unless otherwise indicated herein, the description in this section is not prior art to the claims in this application and is not admitted to be prior art by inclusion in this section.

The present disclosure relates to a developing unit for use in image forming apparatuses of a copying machine, a printer, a facsimile machine, a multifunctional peripheral thereof, and on the like, as well as an image forming apparatus including the same.

An electrophotographic image forming apparatus emits light based on image information read from an original image or image information transmitted from an external device, such as a computer, onto the circumferential surface of an image bearing member on which a photoconductive layer is formed to form an electrostatic latent image, supplies toner from a developing unit to the electrostatic latent image to form a toner image, and thereafter transfers the toner image to paper. The paper, after the transfer process, is subjected to a toner-image fixing process and is thereafter output to the outside.

The configurations of image forming apparatuses have recently become complicated as their processes become faster and color printing has become widespread. The faster processing requires the developing roller and toner stirring member in the developing unit to rotate at high speed, thus resulting in a tendency of the internal pressure of the developing unit becoming greater than the atmospheric pressure. This pressure in the developing unit may cause a possibility that, when toner is supplied from the interior of the developing unit to the image bearing member, part of the toner may float and leak from the toner supply port of the developing unit opposing the image bearing member causing a splashing of the toner. The splashing toner may contaminate the interior of the image forming apparatus.

Thus, the developing unit may be equipped with a suction fan that takes in air between the developing roller and a covering member, such as a developer container, which covers part of the outer circumferential surface of the developing roller. This developing unit may suppress floating toner, even if the developing process becomes faster.

However, this developing unit has a problem in that it needs a fan that sucks out the toner floating in the developer container outside of the developer container, thus increasing the size of the developing unit.

Furthermore, the developing unit may have an air inlet in the wall of the developer container opposing the lower part of the developing roller. With this developing unit, air flows into the developer container through the air inlet, and the air in the developer container that has positive due to the rotation of the developing roller and the magnetic roller is introduced into a dust collection box through an air outlet. With this developing unit, the floating toner in the developer container is recovered in the dust collection box.

However, since the air inlet is provided in the lower wall of the developer container, this developing unit has the possibility that the floating toner in the developer container may leak to the outside through the air inlet.

### SUMMARY

A developing unit according to an embodiment of the present disclosure includes a developer container, a stirring member, a magnetic roller, a developer supply port, and a developer discharge portion. The developer container contains a two-component developer including toner and a magnetic carrier. The stirring member stirs and conveys the developer in the developer container. The magnetic roller carries the developer supplied from the stirring member on the surface thereof as a magnetic brush and conveys the carried magnetic brush by rotation. The developing roller opposes the magnetic roller and an image bearing member, carries the toner in the magnetic brush conveyed by the rotation of the magnetic roller on the surface thereof, and supplies the carried toner to the image bearing member. The developer supply port allows the developer to be supplied into the developer container. The developer discharge portion discharges excessive developer in the developer container. The developer discharge portion includes a discharge blade having a spiral blade and conveys the excess developer, a developer discharge port through which the excess developer conveyed by the discharge blade is discharged to the outside of the developer container, and an air outlet through which an airflow in the developer container passes toward the outside of the developer container. The developer discharge port is located at a position lower than the upper surface of the developer present in the developer discharge portion. The air outlet is located at a position higher than the upper surface of the developer present in the developer discharge portion.

An image forming apparatus according to another embodiment of the present disclosure includes an image bearing member on which an electrostatic latent image is formed; and a developing unit that develops the electrostatic latent image formed on the image bearing member as a toner image. The developing unit includes a developer container, a stirring member, a magnetic roller, a developer supply port, and a developer discharge portion. The developer container contains a two-component developer including toner and a magnetic carrier. The stirring member stirs and conveys the developer in the developer container. The magnetic roller carries the developer supplied from the stirring member on the surface thereof as a magnetic brush and conveys the carried magnetic brush by rotation. The developing roller opposes the magnetic roller and an image bearing member, carries the toner in the magnetic brush conveyed by the rotation of the magnetic roller on the surface thereof, and supplies the carried toner to the image bearing member. The developer supply port allows developer to be supplied into the developer container. The developer discharge portion discharges an excess developer in the developer container. The developer discharge portion includes a discharge blade having a spiral blade and conveys the excess developer, a developer discharge port through which the excess developer conveyed by the discharge blade is discharged outside of the developer container, and an air outlet through which an airflow in the developer container passes toward the outside of the developer container. The developer discharge port is located at a position lower than the upper surface of the developer present in the developer discharge portion. The air outlet is located at a position higher than the upper surface of the developer present in the developer discharge portion.

Additional features and advantages are described herein, and will be apparent from the following Detailed Description and the figures.

### BRIEF DESCRIPTION OF THE FIGURES

FIG. 1 is a schematic diagram illustrating an image forming apparatus including a developing unit according to an embodiment of the present disclosure;

FIG. 2 is a schematic cross-sectional view of a developing unit according to an embodiment of the present disclosure;

FIG. 3 is a plan cross-sectional view of a stirring unit of the developing unit according to an embodiment of the present disclosure; and

FIG. 4 is a plan cross-sectional view of a developer discharge portion of a developing unit according to an embodiment of the present disclosure.

### DETAILED DESCRIPTION

An example apparatus is described herein. Other example embodiments or features may also be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Although an embodiment of present disclosure will be described hereinbelow with reference to the drawings, the present disclosure is not limited by the embodiment.

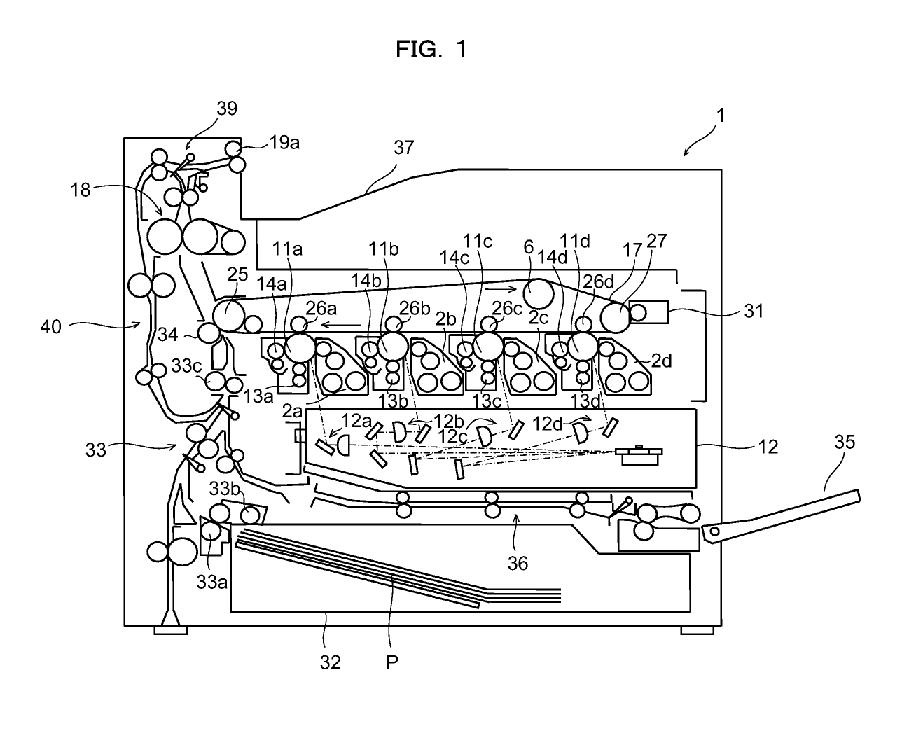

FIG. 1 is a diagram showing a configuration of an image forming apparatus including a developing unit according to an embodiment of the present disclosure. The image forming apparatus 1 is a tandem-type color printer and includes rotatable photoconductors 11a to 11d. The photoconductors 11a to 11d are positioned in correspondence to black, yellow, cyan, and magenta. An organic photoconductor (OPC) is used as a photoconductive material for forming the photoconductive layers of the individual photoconductors. Developing units 2a to 2d, an exposure unit 12, charging units 13a to 13d, and cleaning units 14a to 14d are disposed around the photoconductors 11a to 11d, respectively.

The developing units 2a to 2d are positioned at the right of the photoconductors 11a to 11d so as to face each other, respectively, and supply toner to the photoconductors 11a to 11d. The charging units 13a to 13d are located upstream of the developing units 2a to 2d in the rotating direction of the photoconductors so as to face the surfaces of the photoconductors 11a to 11d, respectively, and uniformly charge the surfaces of the photoconductors 11a to 11d with electricity.

The exposure unit 12 is located below the developing units 2a to 2d and exposes the photoconductors 11a to 11d with light by scanning based on the image data, such as characters and pictures, inputted from a personal computer or the like to an image input section (not shown in FIG. 1). The exposure unit 12 includes a polygon mirror, a plurality of laser light sources, reflecting mirrors, and lenses. Laser light emitted form the laser light sources irradiates the surfaces of the photoconductors 11a to 11d from the downstream side of the charging units 13a to 13d in the rotating direction of the photoconductors via the polygon mirrors, the reflecting mirrors, and the lenses. Electrostatic latent images are formed on the surfaces of the photoconductors 11a to 11d due to the emitted laser light, and the electrostatic latent images are developed to toner images by the developing units 2a to 2d.

An endless intermediate transfer belt 17 is stretched around a tension roller 6, a driving roller 25, and a driven roller 27. The driving roller 25 is rotationally driven by a motor (not shown). The intermediate transfer belt 17 moves due to the rotation of the driving roller 25.

The photoconductors 11a to 11d are arranged side by side under the intermediate transfer belt 17 along the rotating direction thereof (in the direction of the arrow in FIG. 1) so as to be in contact with the intermediate transfer belt 17. Primary transfer rollers 26a to 26d oppose the photoconductors 11a to 11d with the intermediate transfer belt 17 therebetween and are in pressure-contact with the intermediate transfer belt 17 to form a primary transfer section. In the primary transfer section, the toner images on the individual photoconductors 11a to 11d are transferred onto the intermediate transfer belt 17 sequentially at predetermined timing with the rotation of the intermediate transfer belt 17. Thus, a toner image in which the toner images of magenta, cyan, yellow, and black are overlaid is formed on the surface of the intermediate transfer belt 17.

A secondary transfer roller 34 opposes the driving roller 25 with the intermediate transfer belt 17 therebetween and is in pressure-contact with the intermediate transfer belt 17 to form a secondary transfer section. In the secondary transfer section, the toner image on the intermediate transfer belt 17 is transferred to paper P. After the transfer, a belt cleaning unit 31 removes toner remaining on the intermediate transfer belt 17.

A paper feed cassette 32 for storing the paper P is located at a lower part in the image forming apparatus 1. A stacking tray 35 for manually feeding the paper P is located at the right of the paper feed cassette 32. A first paper conveying path 33 that feeds the paper P fed out of the paper feed cassette 32 to the secondary transfer section of the intermediate transfer belt 17 is located at the left of the paper feed cassette 32. A second paper conveying path 36 that feeds the paper P fed out of the stacking tray 35 to the secondary transfer section is located at the left of the stacking tray 35. Furthermore, a fixing section 18 that performs a fixing process on the paper P on which the toner image is formed and a third paper conveying path 39 that feeds the paper P subjected to the fixing process to a paper output section 37 are positioned at the upper left of the image forming apparatus 1.

The paper feed cassette 32 is configured so as to be pulled out of the image forming apparatus 1 (to the front of the plane of FIG. 1). The user can refill paper by pulling the paper feed cassette 32 out of the image forming apparatus 1. The paper P stored in the paper feed cassette 32 is fed out to the first paper conveying path 33 one by one by a pickup roller 33b and a separation roller pair 33a.

The first paper conveying path 33 and the second paper conveying path 36 join together short of a resist roller pair 33c. The paper P is fed to the secondary transfer section by the resist roller pair 33c at the timing at which the image forming operation of the intermediate transfer belt 17 and the paper feeding operation coincide with each other. The toner image on the intermediate transfer belt 17 is secondarily transferred to the paper P, which is fed to the secondary transfer section, by the secondary transfer roller 34 to which a transfer bias is applied, and the paper P is fed to the fixing section 18.

The fixing section 18 includes a fixing belt, which is heated by a heater or the like, a fixing roller that is inscribed with the fixing belt, a pressure roller that is in pressure-contact with the fixing roller with the fixing belt therebetween, and so on. The fixing section 18 performs a fixing process by heating and pressurizing the paper P to which the unfixed toner image is transferred. After the toner image is fixed by the fixing section 18, the paper P is reversed in a fourth paper conveying path 40 as necessary. A toner image is secondarily transferred to the back of the paper P reversed in the fourth paper conveying path 40 by the secondary transfer roller 34, and the toner image is fixed to the back of the paper P by the fixing section 18. The paper P to which the toner image is fixed passes through the third paper conveying path 39 and is output to the paper output section 37 by an output roller pair 19a.

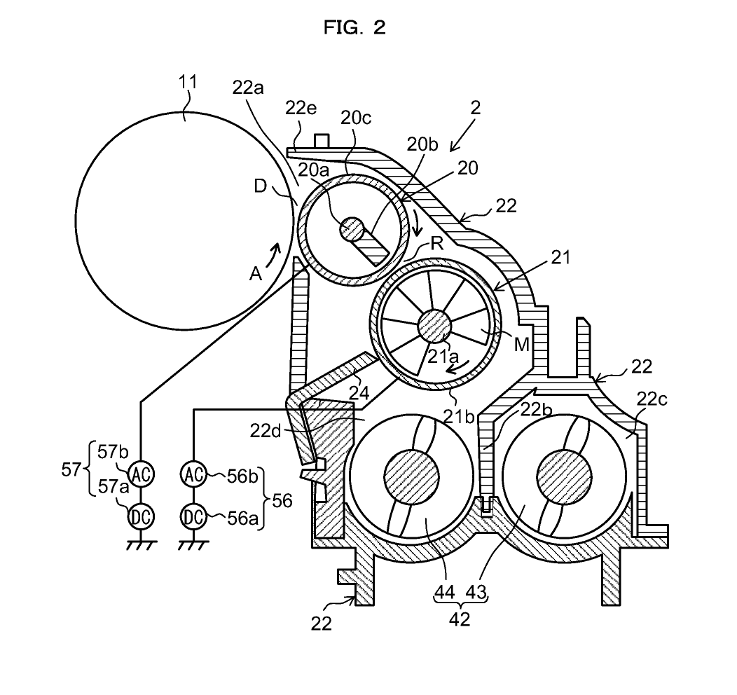

FIG. 2 is a cross-sectional view showing the configuration of the developing unit used in the above image forming apparatus 1. Although the configuration and operation of the developing unit 2a corresponding to the photoconductor 11a shown in FIG. 1 will be described hereinbelow, the configurations and operations of the developing units 2b to 2d are the same as those of the developing unit 2a, and thus, descriptions thereof will be omitted, and reference signs a to d indicating the developing units and the photoconductors of the individual colors will be omitted.

The developing unit 2 includes a developing roller 20, a magnetic roller 21, a regulation blade 24, a stirring member 42, a developer container 22, and so on.

The developer container 22 is made of plastic and defines the outer shell of the developing unit 2. The interior of the developer container 22 is partitioned by a partition 22b located at the lower part of the developer container 22 into a first conveying path 22c and a second conveying path 22d. The first conveying path 22c and the second conveying path 22d accommodate a developer composed of a magnetic carrier and toner. The developer container 22 rotatably holds the stirring member 42, the magnetic roller 21, and the developing roller 20. Furthermore, the developer container 22 has an opening 22a through which the developing roller 20 is exposed to the photoconductor 11 serving as an image bearing member.

The developing roller 20 is located at the right of the photoconductor 11 so as to oppose the photoconductor 11 at a fixed interval therefrom. The developing roller 20 forms a developing area D, at an opposing position close to the photoconductor 11, through which the photoconductor 11 is supplied with toner. The magnetic roller 21 is located at the lower right of the developing roller 20 so as to oppose the developing roller 20 at a fixed interval therefrom. The magnetic roller 21 supplies toner at an opposing portion R close to the developing roller 20 to the developing roller 20. The regulation blade 24 is fixed to the developer container 22 at the lower left of the magnetic roller 21. The stirring member 42 is positioned substantially below the magnetic roller 21.

The stirring member 42 comprises two stirring members, that is, a first stirring member 43 and a second stirring member 44. The second stirring member 44 is located below the magnetic roller 21 and in the second conveying path 22d. The first stirring member 43 is located in the first conveying path 22c so as to be adjacent to the right of the second stirring member 44.

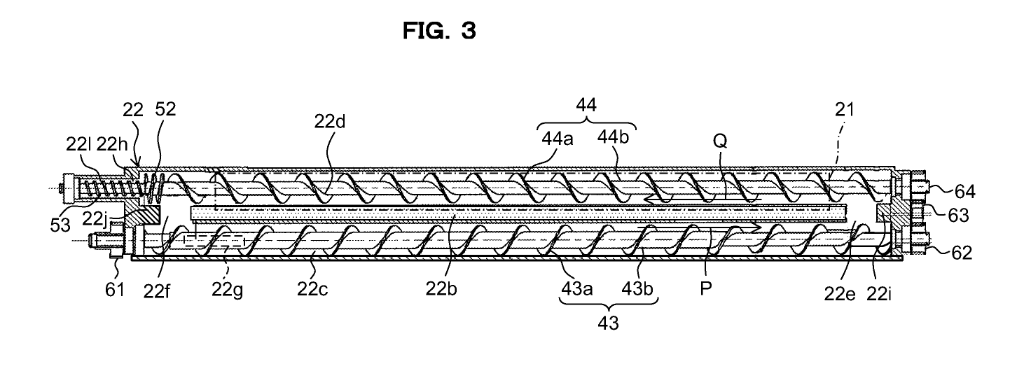

The first and second stirring members 43 and 44 stir the developer to charge the toner in the developer to a predetermined level. Thus, the toner is carried by the magnetic carrier. Communicating portions 22f and 22e (see FIG. 3) are positioned at both ends in the longitudinal direction (in the front-to-back direction of the plane of FIG. 2) of the partition 22b, which separates the first conveying path 22c and the second conveying path 22d from each other. When the first stirring member 43 rotates, the developer is fed in the first conveying path 22c, flows into the second conveying path 22d through one of the communicating portions provided at the partition 22b, and is fed in the second conveying path 22d by the rotation of the second stirring member 44. Thus, the developer circulates in the first conveying path 22c and the second conveying path 22d. The developer is fed from the second stirring member 44 to the magnetic roller 21.

The magnetic roller 21 includes a roller shaft 21a, a magnetic pole member M, and a rotating sleeve 21b made of a nonmagnetic material. The magnetic roller 21 carries the developer supplied from the second stirring member 44 and supplies the toner in the carried developer to the developing roller 20. The magnetic pole member M includes a plurality of sector-shaped cross-sectional magnets whose outer circumferences have different polarities and is fixed to the roller shaft 21a by bonding or the like. The roller shaft 21a is unrotatably supported in the rotating sleeve 21b by the developer container 22, with a predetermined interval between the magnetic pole member M and the rotating sleeve 21b. The rotating sleeve 21b is rotated in the direction indicated by the arrow (clockwise) by a driving mechanism including a motor, a gear, and so on (not shown) and is biased by a power source 56 in which an alternating-current voltage 56b is superimposed on a direct-current voltage 56a. The electrically charged developer forms a magnetic brush and is carried on the surface of the rotating sleeve 21b due to the magnetic force of the magnetic pole member M. The magnetic brush is regulated to a predetermined height by the regulation blade 24.

As the rotating sleeve 21b rotates, the magnetic brush is conveyed while being carried on the surface of the rotating sleeve 21b. When the magnetic brush is raised by the magnetic pole member 20b of the developing roller 20 to come into contact with the developing roller 20, only the toner of the magnetic brush is supplied to the developing roller 20 based on the bias applied to the rotating sleeve 21b.

The developing roller 20 includes a fixed shaft 20a, a magnetic pole member 20b, a cylindrical developing sleeve 20c made of a nonmagnetic metal material, and so on.

The fixed shaft 20a is unrotatably supported by the developer container 22. The developing sleeve 20c is rotatably supported by the fixed shaft 20a. Furthermore, the magnetic pole member 20b made of a magnet is fixed to a position of the fixed shaft 20a opposing the magnetic roller 21 by bonding or the like, with a predetermined interval from the developing sleeve 20c. The developing sleeve 20c is rotated in the direction indicated by the arrow in FIG. 2 (clockwise) by a driving mechanism including a motor, a gear, and so on (not shown). The developing sleeve 20c is subjected to a developing bias by a power source 57 in which an alternating-current voltage 57b is superimposed on a direct-current voltage 57a.

As described above, the developer circulates in the first and second conveying paths 22c and 22d by the first and second stirring members 43 and 44 and is fed to the magnetic roller 21 by the second stirring member 44. The developer is carried on the magnetic roller 21 as a magnetic brush (not shown). The magnetic brush on the magnetic roller 21 is regulated to a predetermined thickness by the regulation blade 24 and thereafter forms a thin toner layer on the developing roller 20 at a portion R at which the magnetic roller 21 and the developing roller 20 oppose due to the potential difference between the bias applied to the magnetic roller 21 and the bias applied to the developing roller 20 and a magnetic field.

The thin toner layer formed on the developing roller 20 is fed to the portion (the developing area D) where the photoconductor 11 and the developing roller 20 oppose by the rotation of the developing roller 20. Since the developing roller 20 is subjected to a predetermined bias, there is a potential difference between the developing roller 20 and the photoconductor 11. This potential difference causes the toner to splash, thus causing the electrostatic latent image to be developed.

Toner remaining on the developing roller 20, that is not used for development, is again fed to the portion R where the developing roller 20 and the magnetic roller 21 oppose by the rotation of the developing roller 20 and is recovered by the magnetic brush on the magnetic roller 21. The magnetic brush is peeled off from the magnetic roller 21 at a portion of the magnetic pole member M of the magnetic roller 21 having the same polarity and thereafter drops into the second conveying path 22d. Furthermore, since the toner that is not used for development is peeled off at the opposing portion R from the developing roller 20 by the magnetic brush on the magnetic roller 21, part of the peeled toner which is not recovered onto the magnetic roller 21 floats in the vicinity of the opposing portion R. The internal pressure of the developer container 22 is high at the opposing portion R. The internal pressure may cause the toner floating in the opposing portion R to pass between the outer circumferential surface of the developing roller 20 and the inner wall surface of the developer container 22 and leak through the opening 22a of the developer container 22.

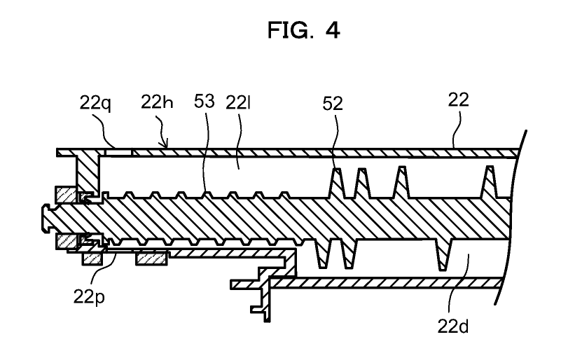

Thus, in this embodiment, the floating toner is discharged, together with excess developer in the stirring unit, from a developer discharge portion 22h (see FIGS. 3 and 4) that discharges the excess developer to a developer recovery bottle to prevent the floating toner from leaking from the opening 22a of the developer container 22.

A detailed configuration for discharging the floating toner from the developer discharge portion 22h is shown in FIGS. 3 and 4. FIG. 3 is a plan cross-sectional top elevational view of the stirring unit. FIG. 4 is a plan cross-sectional view of the developer discharge portion 22h as viewed from a horizontal direction.

As shown in FIG. 3, the developer container 22 includes the first conveying path 22c, the second conveying path 22d, the partition 22b, the upstream-side communicating portion 22e, and the downstream-side communicating portion 22f. The developer container 22 further includes a developer supply port 22g, the developer discharge portion 22h, an upstream-side wall 22i, and a downstream-side wall 22j.

The partition 22b extends in the longitudinal direction of the developer container 22 to separate the first conveying path 22c and the second conveying path 22d in parallel. The upstream-side communicating portion 22e is located between a first end in the longitudinal direction of the partition 22b and the upstream-side wall 22i. The downstream-side communicating portion 22f is located between a second end in the longitudinal direction of the partition 22b and the downstream-side wall 22j. This therefore allows the developer to circulate in the directions indicated by arrow P and arrow Q in the first conveying path 22c, the upstream-side communicating portion 22e, the second conveying path 22d, and the downstream-side communicating portion 22f.

The developer supply port 22g allows for replenishing a new toner and a new magnetic carrier from a developer supply container (not shown) provided at the top of the developer container 22 into the developer container 22 and is located at the upstream-side (at the left in FIG. 3, indicated by the broken line) of the first conveying path 22c.

The developer discharge portion 22h allows for discharging the developer that has become redundant in the first and second conveying paths 22c and 22d due to replenishment of the developer through the developer supply port 22g and is located at the downstream side of the second conveying path 22d.

The first conveying path 22c accommodates the first stirring member 43, and the second conveying path 22d accommodates the second stirring member 44.

The first stirring member 43 includes a rotation shaft 43b and a first spiral blade 43a that is formed in the axial direction of the rotation shaft 43b so as to be integral with the rotation shaft 43b in a spiral form at a fixed pitch. The first spiral blade 43a extends to both ends in the longitudinal direction of the first conveying path 22c and is provided also at portions corresponding to the upstream-side and downstream-side communicating portions 22e and 22f. The rotation shaft 43b is rotatably supported by the upstream-side wall 22i and the downstream-side wall 22j of the developer container 22.

The second stirring member 44 includes a rotation shaft 44b and a second spiral blade 44a that is formed in the axial direction of the rotation shaft 44b so as to be integral with the rotation shaft 44b in an opposite phase from that of the first spiral blade 43a in a spiral form at the same pitch as that of the first spiral blade 43a. The second spiral blade 44a is longer than the axial length of the magnetic roller 21. The second spiral blade 44a is also provided at portions corresponding to the upstream-side communicating portion 22e and the downstream-side communicating portion 22f. The rotation shaft 44b is positioned parallel to the rotation shaft 43b and is rotatably supported by the upstream-side wall 22i and the downstream-side wall 22j of the developer container 22.

Furthermore, the rotation shaft 44b is integrally provided with a reverse spiral blade 52 and a discharge blade 53 together with the second spiral blade 44a.

The reverse spiral blade 52 is positioned in the vicinity of the developer discharge portion 22h and between the developer discharge portion 22h and the second spiral blade 44a. The outer edge of the reverse spiral blade 52 is positioned with a predetermined interval from the inner peripheral surface of the downstream-side wall 22j in the second conveying path 22d. The reverse spiral blade 52 is formed of a blade having a substantially equal outer circumferential length to that of the outer edge of the second spiral blade 44a and formed in an opposite direction (in an opposite phase) from that of the second spiral blade 44a in a spiral form with two or three turns smaller than the pitch of the second spiral blade 44a. Accordingly, when the rotation shaft 44b rotates, a conveying force opposite to the developer conveying direction of the second spiral blade 44a is imparted to the developer by the reverse spiral blade 52, so that the developer is retained. The retained developer is fed to the downstream-side communicating portion 22f. The excess developer in the developer container 22 flows over the outer edge of the reverse spiral blade 52 and is discharged to the developer discharge portion 22h.

The rotation shaft 44b further extends from the interior of the second conveying path 22d into a developer channel 22l of the developer discharge portion 22h. The rotation shaft 44b in the developer channel 22l is provided with the discharge blade 53. The discharge blade 53 is formed of a spiral blade in the same phase as that of the second spiral blade 44a. The discharge blade 53 has a smaller pitch and a smaller outer edge than the second spiral blade 44a. When the rotation shaft 44b rotates, the discharge blade 53 rotates together with the second spiral blade 44a, and the excess developer fed into the developer channel 22l is fed leftwards in the developer channel 22l and is discharged to the developer recovery bottle (not shown) outside the developer container 22.

As shown in FIG. 4, the developer discharge portion 22h has therein the developer channel 22l. The developer channel 22l has a circular cross section. The developer channel 22l accommodates the rotatable discharge blade 53. The lower wall of the developer discharge portion 22h has a developer discharge port 22p for discharging excess developer to the developer recovery bottle (not shown) outside the developer container 22. The upper wall of the developer discharge portion 22h has an air outlet 22q.

The air outlet 22q opposes the developer discharge port 22p at the lower part of the developer channel 22l and is positioned at the upper part of the developer channel 22l. The air outlet 22q circulates air between the developer channel 22l and the interior of the image forming apparatus 1. The configuration in which the air outlet 22q is provided at the upper part in the vertical direction of the developer channel 22l allows air to circulate between the developer channel 22l and the interior of the image forming apparatus 1 irrespective of the amount of the excess developer in the developer channel 22l. Alternatively, the air outlet 22q may be located at an appropriate location, not at the upper part in the vertical direction of the developer channel 22l, depending on the amount of the excess developer and the inside diameter of the developer channel 22l.

In other words, the developer discharge port 22p is located at a position lower than the upper surface of the developer present in the developer channel 22l, and the air outlet 22q is located at a position higher than the upper surface of the developer present in the developer channel 22l.

By locating the air outlet 22q at the upper part of the developer channel 22l, an airflow flowing between the outer circumference of the magnetic roller 21 (see FIG. 2) and the inner wall of the developer container 22, the second conveying path 22d, the developer channel 22l, and the opposing portion R to reach the air outlet 22q is formed because the internal pressure in the developer container 22 is greater at the portion R where the developing roller 20 and the magnetic roller 21 oppose (see FIG. 2).

Accordingly, the toner floating in the opposing portion R is fed in the developer channel 22l from between the outer circumference of the magnetic roller 21 and the inner wall of the developer container 22 and through the second conveying path 22d by the airflow coming from the opposing portion R to the air outlet 22q. The floating toner fed into the developer channel 22l is fed in the developer channel 22l together with the excess developer conveyed into the developer channel 22l by rotation of the discharge blade 53 and is discharged to the developer recovery bottle (not shown) outside the developer container 22 through the developer discharge port 22p. Thus, with this simple configuration in which the developer discharge portion 22h has the air outlet 22q, the floating toner in the developer container 22 can be recovered to the developer recovery bottle through the developer discharge port 22p for discharging the excess developer without increasing the size of the developing unit.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A developing unit comprising:
a developer container containing a two-component developer including toner and a magnetic carrier;
a stirring member that stirs and conveys the developer in the developer container;
a magnetic roller that carries the developer supplied from the stirring member on the surface thereof as a magnetic brush and conveys the carried magnetic brush by rotation;
a developing roller opposing the magnetic roller and an image bearing member, the developing roller carries the toner in the magnetic brush conveyed by the rotation of the magnetic roller on the surface thereof and supplying the carried toner to the image bearing member;
a developer supply port through which the developer is supplied into the developer container;
a developer discharge portion that discharges excess developer in the developer container; and
the developer discharge portion includes a discharge blade having a spiral blade and conveying excess developer, a developer discharge port through which the excess developer conveyed by the discharge blade is discharged outside of the developer container, and an air outlet through which an airflow in the developer container passes toward the outside of the developer container;
the developer discharge port is located at a position lower than the upper surface of the developer present in the developer discharge portion; and
the air outlet is located at a position higher than the upper surface of the developer present in the developer discharge portion.

2. The developing unit according to claim 1, wherein
the air outlet opposes the developer discharge port.

3. An image forming apparatus comprising:
an image bearing member on which an electrostatic latent image is formed; and
a developing unit that develops the electrostatic latent image formed on the image bearing member as a toner image,
the developing unit includes:
a developer container containing a two-component developer including toner and a magnetic carrier;
a stirring member that stirs and conveys the developer in the developer container;
a magnetic roller that carries the developer supplied from the stirring member on the surface thereof as a magnetic brush and conveys the carried magnetic brush by rotation;
a developing roller opposing the magnetic roller and an image bearing member, the developing roller carries the toner in the magnetic brush conveyed by the rotation of the magnetic roller on the surface thereof and supplying the carried toner to the image bearing member;
a developer supply port through which the developer is supplied into the developer container;
a developer discharge portion that discharges excess developer in the developer container;
wherein the developer discharge portion includes a discharge blade having a spiral blade and conveying the excess developer, a developer discharge port through which the excess developer conveyed by the discharge blade is discharged outside of the developer container, and an air outlet through which an airflow in the developer container passes toward the outside of the developer container;
the developer discharge port is located at a position lower than the upper surface of the developer present in the developer discharge portion; and
the air outlet is located at a position higher than the upper surface of the developer present in the developer discharge portion.

4. The image forming apparatus according to claim 3, wherein
the air outlet opposes the developer discharge port.
